(19) United States
(12) Patent Application Publication
(10) Pub. No.: US 2009/0177318 A1
(43) Pub. Date: Jul. 9, 2009

(54) DISPENSER CONTROL SYSTEM

(75) Inventor: Sean S. Sizemore, Winston-Salem, NC (US)

Correspondence Address: WOMBLE CARLYLE SANDRIDGE & RICE, PLLC, ATTN: PATENT DOCKETING, P.O. BOX 7037, ATLANTA, GA, 30357-0037, US

(73) Assignee: B.L. Sizemore Associates, Inc., Kernersville, NC (US)

(21) Appl. No.: 11/968,922

(22) Filed: Jan. 3, 2008

(51) Int. Cl. G06F 17/00

(52) U.S. Cl. 700/236

(57) ABSTRACT

An improvement for dispenser systems of the type having a dispenser controller and at least one dispenser, each dispenser having at least one actuator activated in response to a control signal from the dispenser controller. The dispenser controller is positioned at a location remote from the dispenser and, and includes an input interface or control panel for activating the controller control circuitry to transmit the signal to the dispenser.

### FIELD OF THE INVENTION

The present invention relates generally to dispensing systems, both fountain dispensing and others, in which a dispenser controller remotely controls conventional fountain beverage dispensers and other types of dispensed or vended items.

### BACKGROUND OF THE INVENTION

Valve actuated beverage dispensers, or fountain dispensers and other food and drink dispensers, are used in a variety of applications. Fast food, cafeteria, and self-service restaurants and vending stations often provide one or more fountain dispensers which may be controlled by the customer. As used herein, the term “fountain dispenser” is intended to include soft drinks, coffee, juice, and/or beer delivered from a reservoir through a dispensing valve where they may be mixed with other liquids such as water, into a customer's cup or glass responsive to an actuator. Typically, the fountain dispenser includes a nozzle and an actuator in the form of a lever or button which operates an electrically operated valve to dispense the beverage. The user, after paying the attendant at a remote location, receives a cup. The user then goes to the dispenser, simply places his/her cup under the nozzle and depresses the button or lever for sufficient time to fill the cup with beverage. This may be referred to herein as an “honor system.”

It is not always desirable to allow the customer such complete access to the dispensing process. In retail environments where the fountain dispenser is not monitored, there exists the possibility that the customer will take a beverage without paying or will take more beverage than paid for.

Therefore, in current beverage dispensers there is no control system for the dispenser valves to (1) limit the amount of beverage which may be dispensed, (2) to remotely authorize actuation of the dispenser valve, or (3) maintain various records concerning the dispenser and its contents. Several attempts have been made to improve the dispensing of beverages. For example, U.S. Pat. No. 4,252,253 describes a system wherein multiple dispensing terminals are in communication with a central source of beverage ingredients, however, the dispenser controller is integral with the dispenser. U.S. Pat. No. 6,036,055 is directed to a wireless liquid portion and inventory control system wherein an electronic spout is connected to a bottle of liquor for controlling the amount of liquor manually poured from the bottle. What each of these systems lack, however, is a way to authorize a dispenser, either for mixed or fountain beverages or snack foods, to vend a particular product type or product size from a dispenser that is remote or detached from the controller unit.

Quite sophisticated currency or card-operated dispensing systems have been developed. These dispensing systems dispense a pre-determined amount of a selected drink responsive to a given signal after a card or coin is deposited by the user; however, such dispenser systems have several drawbacks. U.S. Pat. No. 5,513,775 describes a typical system where a currency/card controller is mounted to the side of a single fountain dispenser so that a consumer may purchase a particular type of beverage by inputting a particular type of payment (coins, bills, credit/cash/complimentary cards, etc.). Such an approach is very expensive because a card or currency operated controller must be built into or onto each cooler cabinet which contains or supports the dispensing components. Further, the built-in controller requires additional space. Thereafter, these control systems cannot be retrofitted to conventional fountain dispensers as described above.

More recently, fast food and restaurant operations have expanded into shopping malls and business centers in the form of food courts, where consumers may chose from a variety of different foods and/or beverages that are contained in multiple dispensers arranged throughout a much larger vending area. More specifically, for special events such as conventions, trade shows, sporting events, etc., it is desirable that vending operations be portable. Where a number of vending dispensers are employed, hardwiring the dispensers to one or more controllers may be both impractical and unsafe. As a result, the dispenser systems are generally operated on the aforementioned honor system. While the currently known dispenser controller systems are physically attached to, or built into each of the multiple dispensers, Applicant has recognized a need for a single, centrally located dispenser controller, remotely located and not physically connected to any one dispenser cabinet, that can communicate with all of the dispensers and accept a consumer's selection and payment for foods and beverages for any of the dispensers. Further, with a system comprising multiple dispensers, owners and operators of these systems will have a greater need for real-time information regarding inventory, money collected, and customer preferences to more fully maximize profits from their vending operations.

### SUMMARY OF THE INVENTION

The present invention is then directed to a remote dispenser controller system that Applicant has developed to improve the situation described above. The term “dispenser controller,” as used herein, includes, first of all, (1) a control interface (control panel) operated by an attendant, or (2) a panel operated directly by a customer that receives coins, currency, credit cards, or complimentary cards, and (3) some type of control circuitry that delivers electrical signals to remote dispensers responsive to authorization at the control interface or that both delivers and receives electrical signals from the dispenser. The dispenser controller authorizes the dispenser to dispense a beverage or other item by means of a dispensing activating device (valve or actuator), and may also collect information from the dispenser(s). Further, the remote dispenser controller may be operated by a retail operator/clerk, or directly by a customer using currency, credit card, or complimentary card to authorize the dispensing of even a canned drink, beverage, coffee, ice, or food item from a remote dispenser that cannot otherwise be monitored directly by the clerk. Again, as used herein, a “beverage dispenser” refers to a machine or container that allows liquid contents in the form of soft drinks, coffee, juices, or beer therein to be removed from a reservoir in convenient or prescribed amounts (quantities or volumes). More particularly, while the beverage dispensers referred to herein dispense liquid beverages (with ice), other dispensers referred to herein permit a consumer to chose from a selection of items, such as canned beverages, food, or snack items. Thus, while all dispensers have some type of activating device, the beverage dispenser includes at least one control valve when a beverage or ice is to be dispensed, while other dispensers include other types of actuators when a snack, food, or canned drink is to be dispensed.

In one embodiment, a dispenser controller is provided at a location remote from and operatively connected (hard wired) to at least one remote beverage dispenser. As used herein, the term “remote” is used to refer to a controller that is located at a second location separated from the dispenser(s) by at least a minimal distance. The dispenser is adapted to activate selected valves for selected times responsive to a signal from the remote dispenser controller. The dispenser controller is made up of a user input interface and associated controller control circuitry. The user input interface is configured to permit a retail sales clerk, upon proper payment from a customer, or the customer himself, to authorize the vending of a selected type or size of beverage or other food item at an input point remote from a dispenser. A human authorizes the dispensing process at the user input interface; in the case of a customer, by inserting currency, or a card and making a selection; in the case of an attendant, by receiving payment and making a selection. Upon authorization, the controller control circuitry transmits a signal to the designated remote dispenser. The dispenser also has its control circuitry (dispensing control circuitry). This signal activates an actuator on the dispenser, thus dispensing the selected item in the prescribed amount.

In a second embodiment, a wireless transmitter is provided which receives a signal from the control interface and transmits a radio frequency (RF) signal to a remote receiver on or at the dispenser. As will be appreciated by those skilled in the art, the permissible distance between a transmitter and a receiver is limited only by the strength of the transmitted signal and the sensitivity of the intended receiver.

A conventional currency and/or card panel or keyboard is operatively connected to the controller control circuitry for user/attendant input interface with the system. Thus, the dispenser controller may accept coins, bills, credit cards, prepaid cards, or complimentary cards, for example. Upon receipt of a customer's authorization and selection of product type, as described in greater detail below, the controller control circuitry transmits a signal according to a standard prescribed protocol from the wireless transmitter. The signal is sent to the dispenser and through its control circuitry (dispenser control circuitry) to at least one control valve or actuator of that dispenser to dispense a selected beverage or snack.

A third embodiment is directed to a multiple dispenser system with a dispenser controller/information collector positioned remotely to a plurality of dispenser units. Each of the dispensers has at least one control valve or actuator. A single remote controller is provided to control all dispensers in the system. The communications may be wireless or hard wired. Authorization from a customer or attendant will activate the selected one of the plurality of dispensers to dispense the selected item.

These and other aspects of the present invention will become apparent to those skilled in the art after a reading of the following description of the preferred embodiments when considered with the drawings.

### BRIEF DESCRIPTION OF THE DRAWINGS

FIG. 1 is a schematic representation of a first embodiment of the dispenser control system of the present invention; and

FIG. 2 is a schematic representation illustrating an alternative embodiment of the dispenser control system of the present invention illustrating a single remote controller operating a plurality of dispensers.

### DETAILED DESCRIPTION OF THE PREFERRED EMBODIMENTS

Certain exemplary embodiments of the present invention are described below and illustrated in the attached Figures. The embodiments described are only for purposes of illustrating the present invention and should not be interpreted as limiting the scope of the invention, which, of course, is limited only by the claims below. Other embodiments of the invention, and certain modifications and improvements of the described embodiments, will occur to those skilled in the art, and all such alternate embodiments, modifications and improvements are within the scope of the present invention.

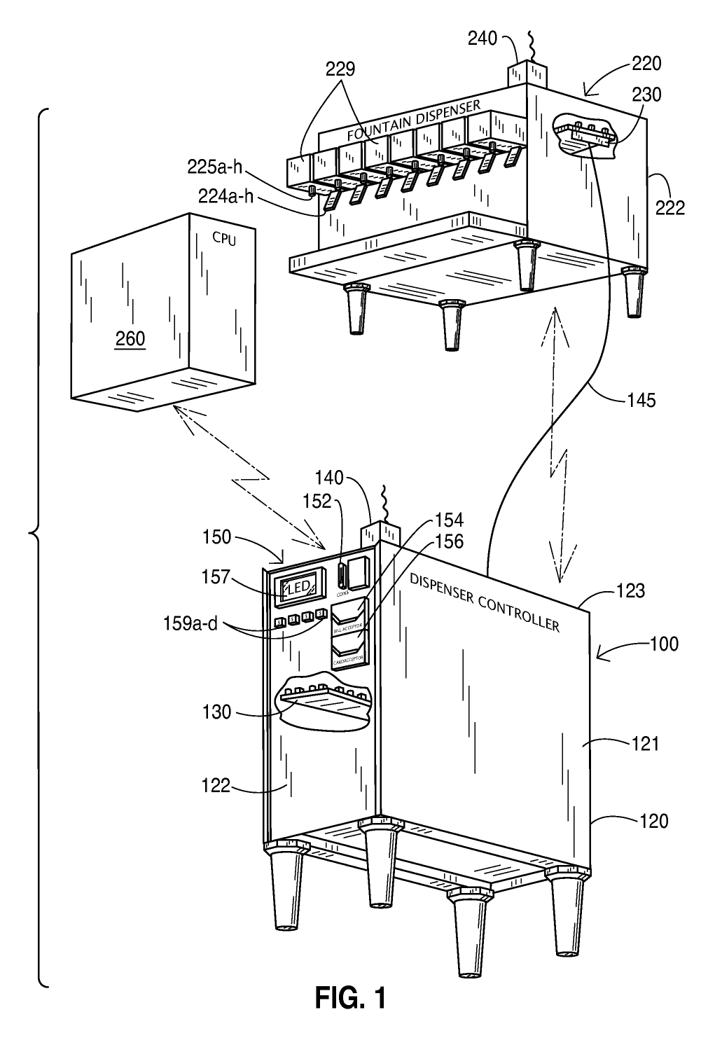

Referring first to FIG. 1, a first embodiment of the present invention includes a dispenser controller, shown generally as 100, for a currency and/or card-operated dispenser system and a dispenser 220. The card may be either a credit card, debit card, or a complimentary card. The dispenser controller 100 illustrated in FIG. 1 comprises a cabinet 120, a wireless transmitter 140, and a customer input interface (control panel) 150. It should be noted here that the term “transmitter 140: and “receiver 240” are sometimes used herein. Both types of devices 140 and 240 can, in reality, be a transmitter/receiver as both can function to send and receive electrical signals.

The cabinet 120 houses a controller control circuitry 130 that is programmed for the dispensing application that is anticipated. For example, the control circuitry 130 may comprise one or more printed circuit boards that are programmed to provide electronic instructions to the fountain or coffee beverage dispenser 220 of FIG. 1, with which the dispenser controller 100 is in electric/electronic communication. In one embodiment, the control circuitry can control eight different devices. As will be described in greater detail below, and as is well known in the electronics art, there are many configurations and sizes for such control circuitry 130 boards or trays.

In the embodiment of FIG. 1, a wireless transmitter 140 is shown. The wireless transmitter 140 is provided for transmitting a radio frequency (RF) signal to a remote/detached dispenser 220. As will be understood, the wireless transmitter 140 is electronically interconnected to and receives signals from the control circuitry 130. Although shown mounted atop the cabinet 120, the wireless transmitter 140 may also be housed within cabinet 120 and may be formed with the control circuitry 130. The exact location and position of the transmitter 140 is again dependent upon the placement and installation of the dispenser controller 100 relative to the dispensers being controlled. Alternatively, the control circuitry 130 of the controller may be electronically interconnected to the control circuitry 230 of the dispenser, described in greater detail below, by hardwiring 145 (FIG. 1). This alternate configuration for interconnection may be more practical where the distance between the controller 100 and the dispenser 220 is great, or where wireless transmission is not practical, may be problematic, or simply may not be desired.

Disposed on the front wall 122 of the cabinet 120 is the user input interface 150 (sometimes referred to as a control panel). As used herein, the term “user input interface” is the keyboard, or other device associated with the controller by which the user inputs information and authorization to dispense product. As shown in FIG. 1, an exemplary user input interface 150 includes a coin acceptor 152, a bill acceptor 154, and a credit/complimentary card acceptor 156, although the interface 150 may be limited to one or more of these, as the vending application requires. An LED or other suitable display 157 is provided to indicate either the price of a vend, the amount of payment that has been accepted by the dispenser controller 100, or the selection of the item to be dispensed. A series of buttons 159a-d are provided for the user/consumer to make a selection of product and/or price, as described by way of examples below. While a description of a preferred embodiment has been illustrated and described, obviously such things as cabinet design, control panels, types of controls, dispenser design, etc., are optional and can be modified without departing from the scope of the invention.

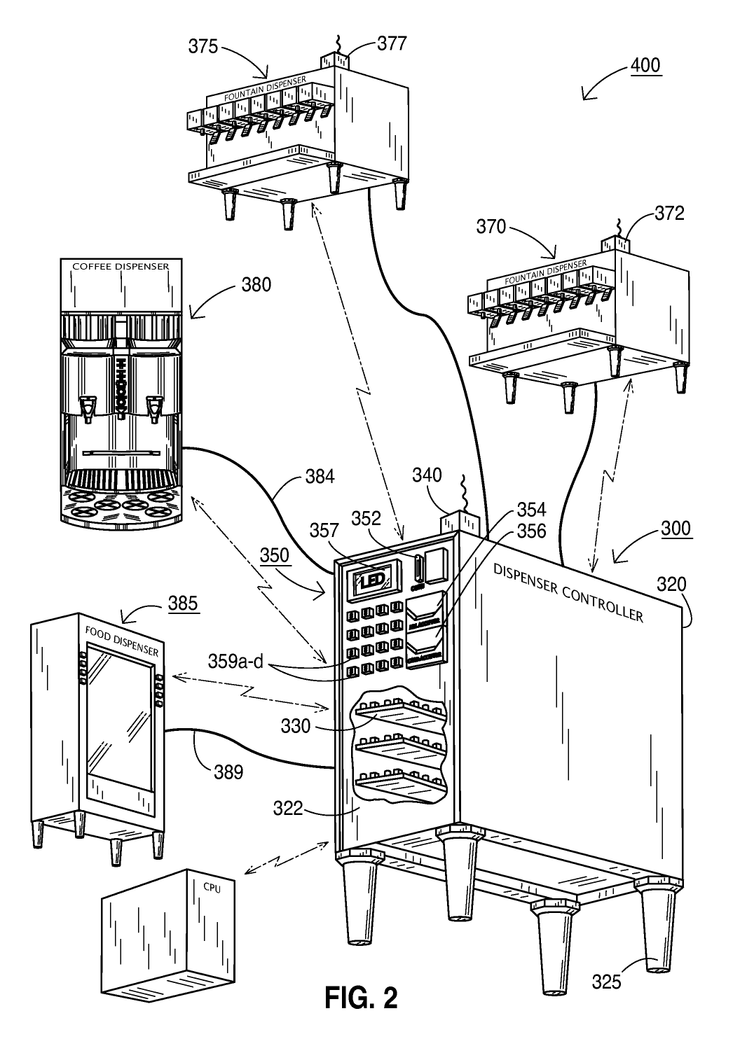

While the dispenser 220 shown in FIG. 1 is typical of a beverage fountain, the system may also include a hot beverage or coffee dispenser or other snack or drink vending type system (FIG. 2). The dispenser shown in FIG. 1 for illustrative purposes includes a box-like cabinet that is adapted to dispense multiple types and/or sizes of beverages by means of dispenser actuators or valves 229 which open to deliver beverages through nozzles 225a-h (i.e., fountain dispensers) when one of the levers 224a-h is depressed. A wireless radio frequency receiver 240 is mounted on the cabinet or, alternatively, is housed within the cabinet structure. Again, the position and installation of the wireless receiver is dependent on the location and installation of the system controller relative to the dispenser. The wireless receiver 240 is capable of receiving an RF signal from the remote RF transmitter 140 of the dispenser controller 100. The wireless receiver 240 is electronically interconnected to dispenser control circuitry 230 that is mounted within the cabinet 222 of the dispenser 220. The dispenser control circuitry 230 may also be constructed as printed circuit boards or cards and controls one or more control valves or actuators 229. As is well known in the art, the control valves or actuators 229 may be electromagnetic/electromechanical (EM) solenoid valves. As those skilled in the art will appreciate, an EM solenoid valve comprises an electrically energized coil of insulated wire which produces a magnetic field within the coil. In particular, the coil surrounds a movable iron core which is pulled to a central position with respect to the coil when the coil is energized by sending current through it. Movement of the coil thus actuates the particular valve with which the solenoid is associated.

Since the dispenser controller of the present invention may be installed with a conventional beverage dispenser, it is necessary that the operation of the dispenser control be configured to an industry accepted protocol. Over the years, the food and beverage industry has developed two technical standards relating to the internal operating controls of food and beverage vending machines. In particular, the National Automatic Merchandising Association (NAMA), and its Vending Technology Standards Committee, in cooperation with the European Vending Association has developed the Multi-Drop Bus/Internet Communication Protocol (MDB/ICP) which is utilized in conjunction with the EVA-DTS. The EVA-DTS provides specifications for electronically storing data in vending machines by describing the structure and content of data fields, methods of interfacing retrieval devices, and a physical interconnect and optical communications system. The Multi-Drop Bus/Internet Communication Protocol is a standard that defines a serial bus interface for electronically controlled vending machines. Both protocols are now universally used in vending machines that employ electronic controls so that all vending and peripheral equipment communicates with each other. This interface standard allows the various components of a vending machine to communicate with the vending machine controller 100. It is the way for the dispenser controller 100 to determine what coins were accepted by the coin acceptor 152, what bills were accepted by the bill acceptor 154, and how much credit is available through the card reader 156, for example. This protocol also allows the dispenser controller 100 to communicate instructions to, and receive date from one or more dispensers in the system 200.

The operation of the system 200 is dependent upon the configuration of the dispenser controller 100 and the dispenser 220 since there are numerous ways to configure the system 200. The following are examples of system configurations and operation.

In addition to controlling the dispensing of beverages and snacks, the control circuitry can also be programmed to maintain a record of the snacks and beverages dispensed from each dispenser, at what time, and/or any other record desired.

### Example One

The four buttons 159a-d are configured for vending price/product size selection by a retail store clerk, for example. For instance, the buttons 159a-d may be programmed to represent $0.50 (small), $1.00 (medium), $1.50 (large), and $2.00 (extra large). Another row of buttons (not shown) might be used to select the type of beverage, and a third row of buttons might select prescribed vending machines in a network (FIG. 2). Upon receipt of payment from a customer for a selected size beverage, the store clerk selects the size to be dispensed by depressing the appropriate button(s). Alternatively, buttons 159 may be keys, or a keyboard. Upon selecting/authorizing the size and type of beverage to be dispensed, the control circuitry generates an appropriate signal either through a hardwired connection to the selected dispenser or via a wireless transmitter 140 to the wireless receiver 240 of the dispenser 220. The received signal is processed by the control circuitry 230 of the dispenser 220. In one configuration, the control circuitry 230 of the dispenser activates all of the solenoids 229 for the dispenser. This permits the consumer to select from any of the beverages in the dispenser. Upon taking the appropriate size cup and depressing the lever or other beverage type selector, the selected beverage of the authorized size is dispensed. Simultaneously, the solenoids for the other beverages are isolated. Since the dispenser controller 100 of the present invention is intended for use with a remote dispenser 220, this control scheme prevents the consumer from dispensing more than one beverage. On the other hand, the signal to the active solenoid is generated so that the solenoid is open for a time corresponding to the volume of beverage to be dispensed. Upon the expiration of the prescribed time, the solenoid is deenergized and closes. This configuration also prevents the consumer from dispensing a larger size beverage than that paid for or from returning to the dispenser for additional beverage.

### Example Two

Again, four buttons 159a-d are configured exclusively for vending price. For instance, the buttons 159a-d may be programmed to represent $0.50, $1.00, $1.50, and $2.00. As in Example One, another row of buttons (not shown) might be used to select the type of beverage, and a third row of buttons might select prescribed vending machines in a network (FIG. 2). In the case of beverages, these prices may represent different sizes of beverages (small, medium, large, extra large). The difference here is that the customer selects a size by depressing the appropriate button(s) and inserting the chosen form of payment in the coin acceptor 154, bill acceptor 156, or card acceptor 156. The LED display 157 then either displays the total entered or the selected price, depending upon the programming of the LED display 157. From there on the operation is the same as in Example One.

### Example Three

Two of the four buttons are configured for product selection and two are programmed for vending price. For instance in FIG. 2, buttons 159a and 159b might be programmed for regular coffee and decaffeinated coffee respectively. Again, another row of buttons (not shown) might be used to select the condiments, and a fourth row of buttons might select prescribed vending machines in a network (FIG. 2). Button 159c and 159d may be programmed to represent $1.00 and $2.00 respectively. In the case of coffee, these prices represent medium and large cups of coffee, for example. Thus, the consumer selects both a coffee type and size by depressing the appropriate buttons and inserting the chosen form of payment in the coin acceptor 352, bill acceptor 354, or card acceptor 356. Again, the signal is transmitted via the wireless transmitter 340 to the wireless receiver 372, 377 of the dispenser 370, 375. The control circuitry of the dispenser activates all of the solenoids for the selected coffee type. This permits the consumer to select from any of the styles of regular coffee, for example. Upon taking the appropriate size cup and depressing the lever, the selected volume of coffee is dispensed. Again, the solenoids for the other coffees are isolated as are the solenoids for decaffeinated coffee.

### Example Four

The four buttons are configured for product selection only. For instance, buttons 159a and 159b might be programmed for regular coffee and decaffeinated coffee respectively. Buttons 159c and 159d may be programmed for a regular and decaffeinated soft drink. Again, one or more additional rows of buttons (not shown) might be used for other allowed selections. In this configuration, only one size is available at a single price. Thus, the consumer selects a single product type by depressing the chosen button and inserting the chosen form of payment in the coin acceptor 152, bill acceptor 154, or card acceptor 156. Again, the signal is transmitted via the wireless transmitter 140 to the wireless receiver 240 of the dispenser 220. The control circuitry 230 of the dispenser 220 activates the specified solenoid 229 for the selected product.

Turning again to FIG. 1, the system 200 may further comprise a remote user computer 260 so that the owner or operator of the vending system 200 can obtain periodic information from the dispenser controller 100. The devices 140 and 240 are adapted to both send and receive information via electrical signals With the protocol described above, the owner/operator can obtain sales and inventory information. For example, sales of particular brands in terms of units or volume can be obtained. The amount of money collected can also be provided, etc. This assists the operator in knowing when to restock and what products are favored by consumers.

Turning now to FIG. 2, an alternative embodiment of the present invention is directed to a dispenser controller, shown generally as 300, for a currency and/or card operated dispenser system comprising multiple dispensers and multiple types of dispensers. The dispenser controller 300 again comprises a cabinet 320 and a customer input interface 350 on one face 322 of the cabinet 320. The dispenser controller may be hard wired to the dispenser or may include a wireless transmitter 340.

The cabinet 320 again houses a control circuitry 330 that is programmed for the dispensing applications that are anticipated. As shown in the FIG. 2, the control circuitry 330 here comprises several printed circuit boards that are programmed to provide electronic instructions to multiple beverage or snack dispensers to which the dispenser controller 300 is in electric/electronic communication. Whereas in some arrangements a single printed circuit card can control up to eight devices, so four cards are included, the control circuitry can control up to thirty-two different devices. In other arrangements a single printed circuit board could control all 32 devices, and perhaps even more. In the embodiment of FIG. 2, an optional wireless transmitter 340 is shown. The wireless transmitter 340 is provided for transmitting radio frequency (RF) signal to any of the plurality of remote/detached dispensers. Again, the transmitter 340 is shown mounted atop the cabinet 320, but again may also be housed within cabinet 320 and may be formed with the control circuitry. The exact location and position of the transmitter 340 is again dependent upon the placement and installation of the dispenser controller 300 relative to the system of dispensers being controlled.

Disposed on the front wall 322 of the cabinet 320 is the user input interface 350. As shown in FIG. 2, the exemplary user input interface 350 again includes a coin acceptor 352, a bill acceptor 354, and a cash card or credit card acceptor 356. An LED or other suitable display 357 again is provided to indicate either the price of a vend or the amount of payment that has been accepted by the dispenser controller 300. Since the dispenser controller 300 is configured to control multiple dispensers, the number of buttons 359 is increased since the customer may have significantly more vending choices. As an alternate to the input interface 350 illustrated in FIG. 2 and described above, a conventional 12 key touch control pad which receives all types of currency and card inputs may be utilized.

Also, as shown in FIG. 2, a multi-dispenser currency/card dispenser system 400 is shown. The dispenser system 400 includes the a remote dispenser controller 300 as described above, and a plurality of remote/detached dispensers, shown here as 370, 375, 380, and 385. In addition to the exemplary beverage dispensers, dispenser 385 is illustrative of a snack dispenser. The beverage dispensers 370, 375 and 380 function in the same manner as described above in system 200. With respect to the snack dispenser 385, a signal from the dispenser controller 300 would permit a consumer to select a particular snack item or a group of snack items having the same price. Again, upon payment and selection by the consumer, the signal would activate the button or group of buttons on the snack dispenser 385 and isolate others. This is similar to the operation as described above for the beverage dispenser, except that valves are not required for dispensing snack items.

As shown in FIG. 2, wireless transmitters/receivers 372 and 377 are installed on respective dispensers 370 and 375. Alternatively, however, some or all of the dispensers may be electronically hardwired to the dispenser controller 300 via cables such as cables 384 and 389 to dispensers 380 and 385 respectively. Hard wiring may be more desirable when a dispenser is too far from the dispenser controller 300 to get a reliable signal, or is otherwise in a location where a wireless signal would be prohibitive, e.g., in a concrete basement location.

Although the present invention has been described with exemplary embodiments, it is to be understood that modifications and variations may be utilized without departing from the spirit and scope of the invention, as those skilled in the art will readily understand. Such modifications and variations are considered to be within the purview and scope of the appended claims and their equivalents.

We claim:

1. In a dispenser system having a dispenser controller and at least one beverage dispenser, the beverage dispenser having at least one dispensing valve activated in response to a control signal from the dispenser controller, the improvement comprising:
(a) the dispenser controller being positioned at one location and the dispenser being positioned at a second location spaced from and remote from the first location;
(b) both the dispenser and the dispenser controller each including control circuitry which receive and transmit communication signals between the controller and the dispenser;
(c) the dispenser controller further having an input interface receiving authorization from a human to activate the control circuitry and transmit the control signal to the control circuitry of the at least one dispenser.

2. The dispenser system of claim 1 the dispenser controller is authorized responsive to at least one of the group consisting of currency, credit card, complimentary card, and an attendant.

3. The dispenser system of claim 2 wherein both the controller and the dispenser control circuitry are configured to the Multi-Drop Bus/Internal Communication Protocol.

4. The dispenser system according to claim 1 wherein the dispenser controller comprises a wireless transmitter interconnected to the control circuitry to transmit a radio frequency signal from the controller control circuitry to a dispenser receiver to activate the dispenser control circuitry.

5. The dispenser system according to claim 1 wherein the dispenser circuitry provides electrical signals concerning information about inventory and usage to the controller control circuitry.

6. A dispenser system, comprising:
(a) at least one beverage dispenser having at least one dispensing valve;
(b) a dispenser controller being positioned at one location and the beverage dispenser being positioned at a second location spaced from and remote from the first location;
(c) both the beverage dispenser and the dispenser controller each having control circuitry;
(d) the dispenser controller further having an input interface receiving authorization from a human to activate the controller control circuitry to transmit a control signal to the at least one beverage dispenser control circuit to activate and deactivate the at least one dispensing valve.

7. The system of claim 6 wherein the dispenser controller is authorized responsive to one of the group consisting of currency, credit card, complimentary card, and an attendant.

8. The dispenser system of claim 6 wherein both the controller and the dispenser control circuitry are configured to the Multi-Drop Bus/Internal Communication Protocol.

9. The system of claim 6 wherein the input interface is operable by a user or an attendant.

10. The system according to claim 6 wherein the dispenser controller comprises a wireless transmitter interconnected to the controller control circuitry to transmit a radio frequency signal to the at least one dispenser to activate the dispenser control circuitry, and the dispenser includes a wireless receiver interconnected to deliver a control signal to the at least one valve.

11. The system according to claim 6 wherein the dispenser control circuitry provides electrical signals concerning information about usage and inventory to the controller control circuitry.

12. A dispenser system, comprising:
(a) a plurality of dispensers, at least one of the dispensers being a beverage dispenser, each dispenser having:
(i) at least one dispensing activating device activated in response to an electrical signal to dispense a selected item;
(ii) dispenser control circuitry interconnected to the at least one dispensing activating device;
(b) a remote dispenser controller having:
(i) controller control circuitry;
(ii) input interface receiving authorization from a human to activate the controller control circuitry and transmit a control signal to the dispenser control circuitry of the selected one of the plurality of dispensers; and
(c) electronic communication between the controller control circuitry and the control circuitry of each of the plurality of dispensers over which the control signals are transmitted.

13. The system of claim 12 wherein the plurality of dispensers are selected from the group consisting of a fountain beverage dispenser, a can dispenser, a bottle dispenser, a hot beverage dispenser, a cold food dispenser, a hot food dispenser, and a snack dispenser.

14. The system of claim 12 wherein both the controller and the dispenser control circuitry are configured to the Multi-Drop Bus/Internal Communication Protocol.

15. The system of claim 12 wherein the electronic communication between the control circuitry of the dispenser controller and the control circuitry of at least one of the plurality of dispensers comprises:
(a) a wireless receiver interconnected to the actuator of the at least one of the plurality of dispensers; and
(b) a wireless transmitter interconnected to the control circuitry of the dispenser controller, wherein the input interface activates the control circuitry of the dispenser controller to transmit a radio frequency signal from the wireless transmitter to the wireless receiver of the at least one dispenser to selectively activate one of the activating devices.

16. The system of claim 12 wherein the electronic communication between the control circuitry of the dispenser controller and the control circuitry of at least one of the plurality of dispensers comprises a hardwired connection.

17. The system according to claim 12 wherein the dispenser control circuitry provides electrical signals concerning information about inventory and usage to the controller control circuitry.
